(19) United States
(12) Patent Application Publication
(10) Pub. No.: US 2026/0061807 A1
(43) Pub. Date: Mar. 5, 2026

(54) AUTOMOBILE SUNROOF SUNSHADE CURTAIN STRUCTURE

(71) Applicants: Golde Shanghai Co.,Ltd, Shanghai (CN); CIE Golde Shanghai Innovation Co.,Ltd, Shanghai (CN)

(72) Inventors: Jian ZHANG, Shanghai (CN); Saihua ZHENG, Shanghai (CN); Pengtai ZHAO, Shanghai (CN); Chenguang NIU, Shanghai (CN)

(73) Assignees: Golde Shanghai Co.,Ltd, Shanghai (CN); CIE Golde Shanghai Innovation Co.,Ltd, Shanghai (CN)

(21) Appl. No.: 19/107,048

(22) PCT Filed: Aug. 9, 2023
(86) PCT No.: PCT/CN2023/112051

§ 371 Date: Feb. 27, 2025

(30) Foreign Application Priority Data
Aug. 31, 2022 (CN) 202211056916.X

(51) Int. Cl. B60J 7/00; B60J 7/043; B60Q 3/208

(52) U.S. Cl. CPC B60J 7/0007; B60Q 3/208; B60J 7/043

(57) ABSTRACT

An automobile sunroof sunshade curtain structure includes a first light-transmitting layer, a frame assembly including two guide rails symmetrically provided below left and right sides of the first light-transmitting layer, and a sunshade curtain assembly. A second light-transmitting layer is further provided below the first light-transmitting layer to form a hollow layer between the two layers. A curtain fabric of the sunshade curtain assembly is located in the hollow layer. The present invention mitigates the natural sagging of the curtain fabric without affecting its normal operation by adding the second light-transmitting layer. This design expands the head space for passengers and allows for better control of the gap size between the curtain fabric and the headliner. Meanwhile, a light-emitting portion below the first light-transmitting layer creates a light pattern with the second light-transmitting layer or curtain fabric, providing illumination and enhancing the automobile's interior aesthetics.

### FIELD OF THE INVENTION

The present invention relates to the technical field of automobile sunroof, and in particular to an automobile sunroof sunshade curtain structure.

### BACKGROUND OF THE INVENTION

The automobile sunroof enhances the passenger experience by offering passengers a wider view of the outside scenery. The sunroof sunshade curtain structure allows passengers to adjust the light transmittance of the sunroof, enabling it to transition from fully transparent to partially transparent, and finally to completely opaque.

As shown in FIGS. 1-3, the existing automobile sunroof sunshade curtain structure includes a light-transmitting layer 1, a frame assembly 2, a sunshade curtain assembly 3, and a driving assembly 4. The light-transmitting layer 1 is fixedly disposed on the frame assembly 2. The frame assembly 2 is disposed in an opening at a top of the automobile and includes two guide rails 21. The two guide rails 21 are symmetrically provided below left and right sides of the light-transmitting layer 1. The sunshade curtain assembly 3 includes a first pull rod 33, a reel 32, and a curtain fabric 31 connected between the first pull rod 33 and the reel 32. The reel 32 is fixed between the two guide rails 21. The driving assembly 4 includes a driving motor 41, a gear disposed on an output shaft of the driving motor 41, two drawstrings 42 meshed with the gear, and sliders 43 connected to one end of each of the drawstrings 42. Both the drawstrings 42 and the sliders 43 are disposed in the guide rails 21. The drawstrings 42 can drive the sliders 43 to slide in the guide rails 21. The sliders 43 are respectively connected to ends of the first pull rod 33. When the driving motor 41 rotates the gear clockwise or counterclockwise, the drawstrings 42 pull the sliders 43 to move closer to or further away from the reel 32 to wind the curtain fabric 31 onto the reel 32 or unfold it outward. The driving motor 41 and the reel 32 may be arranged on a front side or a rear side of the light-transmitting layer 1.

As shown in FIG. 4, a connecting shaft 36 is fixed to the frame assembly 2. An end portion of the reel 32 is connected to the connecting shaft 36 through a torsion spring. The torsion spring generates a pre-tightening force so that the reel 32 has a rotation tendency to store the curtain fabric 31 on the reel 32.

As shown in FIG. 5, the curtain fabric 31 has a relatively large area. If only front and rear sides of the curtain fabric 31 are fixed by the first pull rod 33 and the reel 32, left and right sides of the curtain fabric 31 will naturally sag. In the prior art, guide belts 34 extending along a length direction (i.e., a front-rear direction) of the curtain fabric 31 are additionally provided. The guide belts 34 on both the left and right sides of the curtain fabric 31 are disposed in the guide rails 21 to ensure that the sag on the left and right sides of the curtain fabric 31 remains within a controllable range.

As shown in FIG. 1 and FIG. 2, since the curtain fabric 31 is located below the light-transmitting layer 1, when the curtain fabric 31 is made of the same fabric as a headliner 5 of an automobile interior, the overall aesthetics of the automobile interior is enhanced. However, this structure still has the following problems.
1. The distance between the light-transmitting layer 1 and the curtain fabric 31 is typically between 30 and 80 mm, which occupies a significant amount of head space for passengers;
2. The perimeter of the curtain fabric 31 is supported by the guide belts 34, the first pull rod 33, and the reel 32 to prevent sagging. However, due to the natural flexibility of the fabric, the center still droops slightly, occupying the head space for passengers;
3. The gap between the curtain fabric 31 and the headliner 5 is challenging to control accurately because the curtain fabric naturally sags. This sagging can lead to an uneven gap, negatively impacting the overall aesthetics of the automobile interior;
4. The proximity of the curtain fabric 31 to passengers'heads may result in static electricity buildup during operation, which can attract their hair and cause discomfort;
5. The curtain fabric 31 is exposed in the automobile interior and is prone to dirt.

The issues mentioned above are all caused by the fact that the curtain fabric 31 is provided below the light-transmitting layer 1, which results in insufficient distance between the curtain fabric 31 and the passengers'heads. To address these issues, a new type of automobile sunroof sunshade curtain structure is urgently needed.

### SUMMARY OF THE INVENTION

The present invention provides an automobile sunroof sunshade curtain structure with double light-transmitting layers, and a curtain fabric is disposed between the double light-transmitting layers.

The automobile sunroof sunshade curtain structure includes a first light-transmitting layer, a frame assembly, and a sunshade curtain assembly. The frame assembly includes two guide rails. The two guide rails are symmetrically provided below left and right sides of the first light-transmitting layer. The automobile sunroof sunshade curtain structure further includes a second light-transmitting layer provided below the first light-transmitting layer. A hollow layer is formed between the second light-transmitting layer and the first light-transmitting layer. A curtain fabric of the sunshade curtain assembly is disposed in the hollow layer.

Preferably, the two guide rails are respectively connected to left and right sides of the second light-transmitting layer. One side (either front or rear) of the second light-transmitting layer is connected to the first light-transmitting layer, while the opposite of the second light-transmitting layer is provided with an opening that allows the curtain fabric to enter the hollow layer.

Preferably, the left sides of the first and second light-transmitting layers and a left guide rail are connected by an edging formed through an encapsulation process; the right sides of the first and second light-transmitting layers and a right guide rail are connected by an edging formed by the encapsulation process.

Preferably, both the left and right sides of the first light-transmitting layer are connected to fasteners through the edging formed by the encapsulation process. First ends of the guide rails are connected to the second light-transmitting layer, and second ends of the guide rails are detachably connected to fasteners.

Preferably, the front side or the rear side of the second light-transmitting layer is connected to the first light-transmitting layer by the edging formed through the encapsulation process or an adhesive.

Preferably, a support member connected to the first light-transmitting layer is provided at a bottom of the opening.

Preferably, the automobile sunroof sunshade curtain structure further includes a light-emitting portion electrically connected to a power supply. The light-emitting portion is arranged below the first light-transmitting layer and works in conjunction with the second light-transmitting layer and/or the curtain fabric to form a light-emitting pattern.

Preferably, a plurality of pattern portions is provided on an upper surface of the second light-transmitting layer. The light emitted by the light-emitting portion enters the second light-transmitting layer and propagates within the layer. Upon reaching the pattern portion, the light is refracted or scattered and subsequently emitted from a lower surface of the second light-transmitting layer.

Preferably, the light-emitting portion includes a transparent display screen. The transparent display screen is arranged on the upper surface of the second light-transmitting layer.

Preferably, the curtain fabric includes a plurality of optical fibers extending along a front-rear direction of the second light-transmitting layer. The light emitted by the light-emitting portion enters the optical fibers through an end portion of the optical fibers.

The present invention has the following beneficial effects. The present invention mitigates the natural sagging of the curtain fabric without affecting its normal operation by adding the second light-transmitting layer to form the hollow layer. This design not only expands the head space for passengers but also allows for better control of gap size between the curtain fabric and the headliner, thereby avoiding issues such as reduced aesthetics, comfort, and neatness due to the sagging and exposure of the curtain fabric, and significantly enhancing the overall riding experience of the passengers.

### BRIEF DESCRIPTION OF DRAWINGS

FIG. 1 is a schematic diagram of a sunroof sunshade curtain structure in a front-rear direction according to the prior art;

FIG. 2 is a schematic diagram of a sunroof sunshade curtain structure in a left-right direction according to the prior art;

FIG. 3 is a schematic diagram of a sunroof sunshade curtain structure according to the prior art;

FIG. 4 is a cross-sectional view along line A-A in FIG. 3;

FIG. 5 is a cross-sectional view along line B-B in FIG. 3;

FIG. 6 is a schematic diagram of an automobile sunroof sunshade curtain structure according to the present invention;

FIG. 7 is a schematic diagram of an assembly of sliders, a pull rod, and a curtain fabric;

FIG. 8 is a cross-sectional view along line C-C in FIG. 6;

FIG. 9 is a cross-sectional view along line D-D in FIG. 6, with left and right sides of a curtain fabric not connected to anything;

FIG. 10 is a cross-sectional view along line D-D in FIG. 6, with left and right sides of a curtain fabric connected to an elastic guide belt, respectively;

FIG. 11 is a schematic diagram of a detachable connection between a second light-transmitting layer and a first light-transmitting layer through guide rails;

FIG. 12(a)-12(c) are three cross-sectional views along line E-E in FIG. 6;

FIG. 13 is a cross-sectional view along line F-F in FIG. 6 with a connecting shaft;

FIG. 14 is a schematic diagram of a relative position of a reel and a connecting shaft;

FIG. 15 is a cross-sectional view along line F-F in FIG. 6 without a connecting shaft;

FIG. 16 is a schematic diagram of a relative position of a support member;

FIG. 17 is a schematic diagram of an adhesive structure between a front side of a first light-transmitting layer and a front side of a second light-transmitting layer;

FIG. 18 is a schematic diagram of a relative position of a light-emitting portion and a second light-transmitting layer and an enlarged schematic diagram of a pattern portion according to Embodiment 1;

FIG. 19 is a schematic diagram of an optical path according to Embodiment 1;

FIG. 20 is a schematic diagram of a left side connection structure of an LED transparent display screen according to Embodiment 2;

FIG. 21(a)-21(b) are schematic diagrams of front and rear side connection structures of an LED transparent display screen according to Embodiment 2;

FIG. 22 is a schematic diagram of a left side connection structure of an OLED transparent display screen according to Embodiment 2;

FIG. 23 is a schematic diagram of a relative position of optical fibers in a curtain fabric according to Embodiment 3;

FIG. 24 is a schematic diagram of an optical path in a curtain fabric according to Embodiment 3;

FIG. 25 is a schematic diagram of a relative position of a light-emitting portion disposed on a front side of a curtain fabric according to Embodiment 3;

FIG. 26 is a schematic diagram of a relative position of a light-emitting portion disposed on a rear side of a curtain fabric according to Embodiment 3; and

FIG. 27 is a diagram of an optical path in an optical fiber sheath according to Embodiment 3.

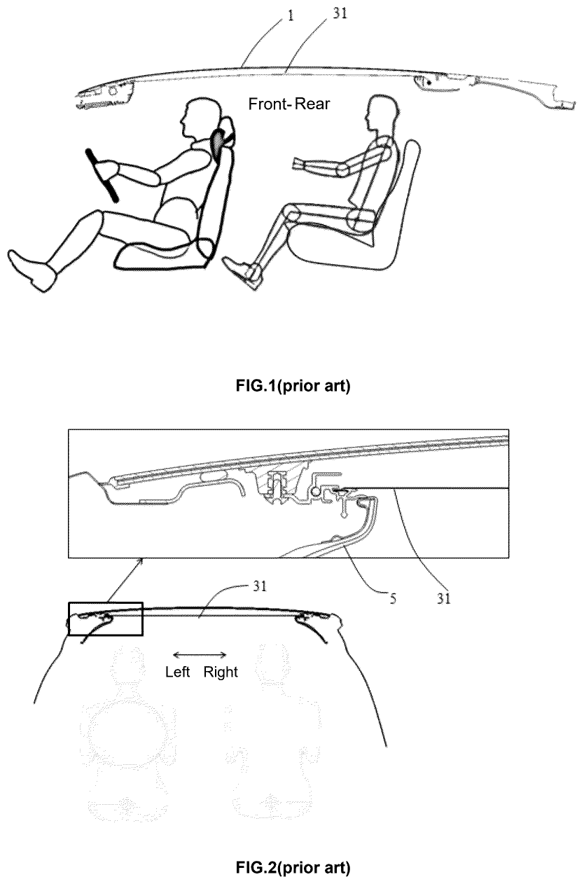

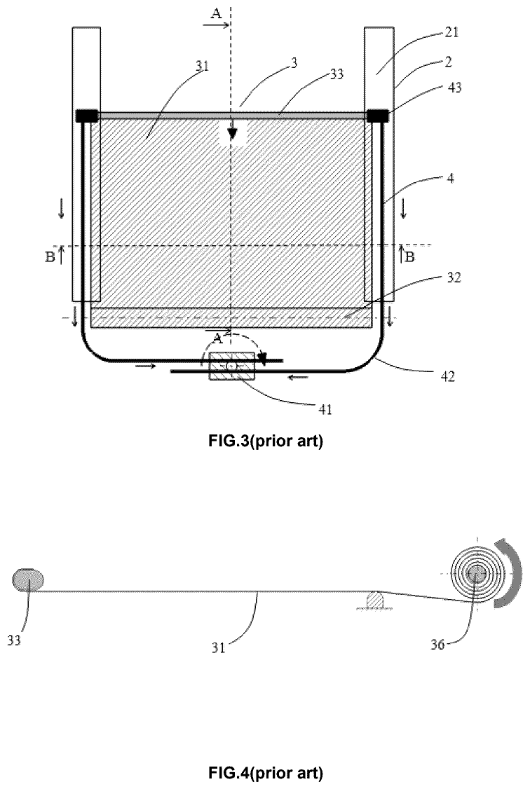

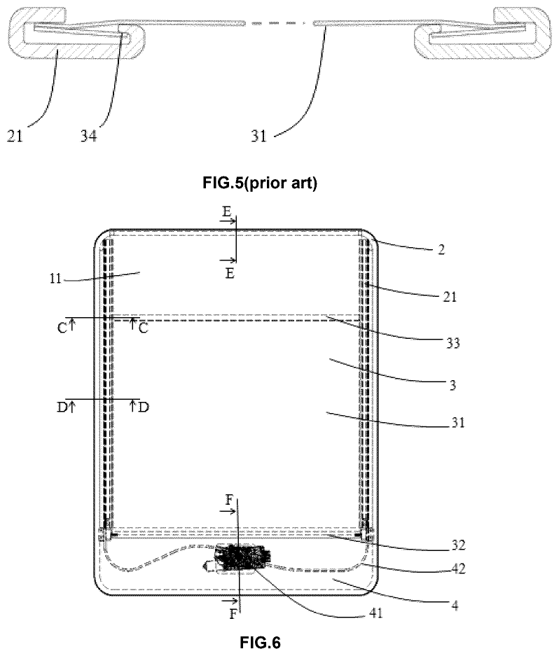

### REFERENCE NUMERALS

1 Light-transmitting layer
11 The first light-transmitting layer
12 The second light-transmitting layer
121 Pattern portion
13/131/132 Edging
14 Hollow layer
141 Opening
15 Support member
16/161/162 Adhesive
17 Nut
171 Screw
2 Frame assembly
21 Guide rail
22 Assembly space
3 Sunshade curtain assembly
31 Curtain fabric
311 Weft thread
312 Warp thread
32 Reel
33 First pull rod
331 First fixing part
332 Second fixing part
34 Guide belt
35 Support
36 Connecting shaft
37 Elastic guide belt
4 Driving assembly
41 Driving motor
42 Drawstring
43 Slider
5 Headliner
61/62/63 Light Bar
621 Light holder
7 Second pull rod
71 Light-transmitting portion
72 Connecting portion
8 Optical fiber
9 Optical fiber sheath
91 Notch
101 LED transparent display screen
102 Light holder
103 OLED transparent display screen
104 Light holder

### DETAILED DESCRIPTION

Specific embodiments of the present invention are further described in detail below with reference to the accompanying drawings. These embodiments are merely used to illustrate the present invention and are not intended to limit the present invention.

In the description of the present invention, it should be noted that the terms “center”, “up”, “down”, “front”, “rear”, “left”, “right”, “top”, “bottom”, “inside”, “outside” etc. indicate directions or positional relationships based on the directions or positional relationships shown in the accompanying drawings. The terms are provided solely for the convenience of describing the present invention and simplifying the description, rather than indicating or implying that the device or element referred to must have a specific direction or be constructed and operated in a specific direction. Therefore, the terms should not be interpreted as limiting the present invention. Furthermore, the terms “first”, “second” and the like are used for descriptive purposes only and should not be construed as indicating or implying relative importance.

In the description of the present invention, it should be noted that, unless otherwise clearly specified and limited, terms such as “mounted”, “connected” and “connection” should be broadly understood. For example, it can be a fixed connection, a detachable connection, or an integral connection; it can be a direct connection or an indirect connection through an intermediate medium, or it can be the internal connection of two elements. For those skilled in the art, the specific meanings of the above terms in the context can be understood according to the specific situation.

FIG. 6 is a schematic diagram of an automobile sunroof sunshade curtain structure according to the present invention. In the following description, the illustration in FIG. 6 is used as a reference basis for directions. An upward direction is defined as perpendicular to a drawing plane and facing outward. A downward direction is defined as perpendicular to the drawing plane and facing inward. A front direction is defined as upward along the drawing plane and a rear direction is defined as downward along the drawing plane. A right direction is defined as rightward along the drawing plane and a left direction is defined as leftward along the drawing plane.

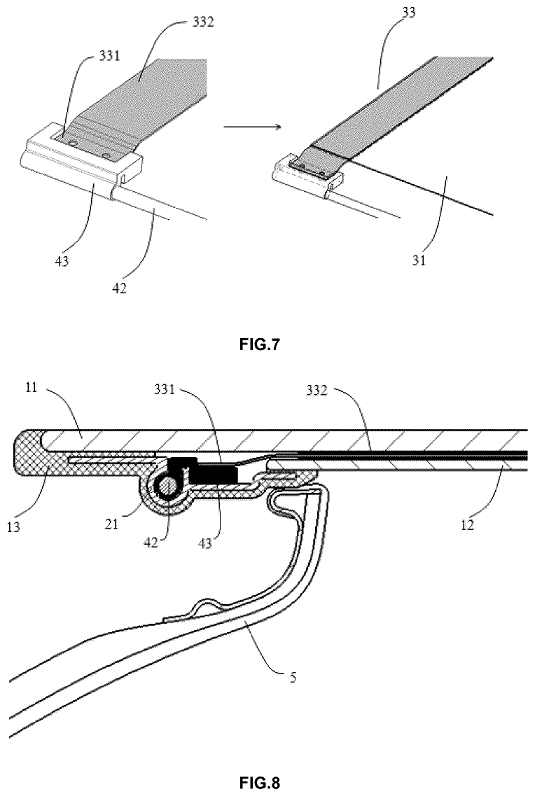

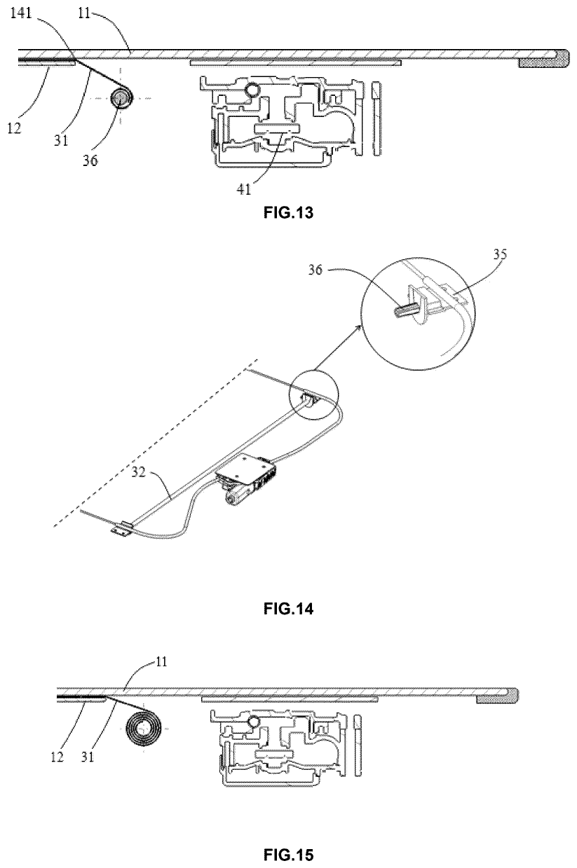

As shown in FIGS. 6-9, the automobile sunroof sunshade curtain structure of the present invention includes a first light-transmitting layer 11, a frame assembly 2, a sunshade curtain assembly 3, and a driving assembly 4. The frame assembly 2 includes two guide rails 21. The two guide rails 21 are symmetrically provided below left and right sides of the first light-transmitting layer 11. Furthermore, the present invention includes a second light-transmitting layer 12 below the first light-transmitting layer 11. A hollow layer 14 is formed between the second light-transmitting layer 12 and the first light-transmitting layer 11. A curtain fabric 31 of the sunshade curtain assembly 3 is disposed in the hollow layer 14. In order to firmly fix the second light-transmitting layer 12 and prevent the second light-transmitting layer 12 from hindering the normal operation of the curtain fabric 31, the two guide rails 21 are respectively connected to left and right sides of the second light-transmitting layer 12. A front or rear side of the second light-transmitting layer 12 is connected to the first light-transmitting layer 11, while the opposite is provided with an opening that allows the curtain fabric 31 to enter. The driving motor 41 of the driving assembly 4 and the reel 32 of the sunshade curtain assembly 3 can be arranged on a front side or rear side of the first light-transmitting layer 11. In the present invention, the driving motor 41 and the reel 32 are arranged on the rear side of the first light-transmitting layer 11. Correspondingly, the front side of the second light-transmitting layer 12 is connected to the first light-transmitting layer 11, and the rear side of the second light-transmitting layer 12 is provided with an opening 141 that allows the curtain fabric 31 to enter the hollow layer 14 from the back to the front, as shown in FIG. 13. Preferably, the first light-transmitting layer 11 and the second light-transmitting layer 12 are transparent glass or organic glass (e.g., acrylic).

The present invention mitigates the natural sagging of the curtain fabric 31 without affecting its normal operation by adding the second light-transmitting layer 12 to form the hollow layer 14. This design not only expands the head space for passengers but also allows for better control of gap size between the curtain fabric 31 and the headliner 5, thereby avoiding issues such as reduced aesthetics, comfort, and neatness due to the sagging and exposure of the curtain fabric, and significantly enhancing the overall riding experience of the passengers.

As shown in FIGS. 8-10, in a specific embodiment of the present invention, a width of the second light-transmitting layer 12 is less than a width of the first light-transmitting layer 11. The left sides of the first and second light-transmitting layers 11,12 and a left guide rail 21 are connected by an edging 13 formed through an encapsulation process. Similarly, the right sides of the first and second light-transmitting layers 11,12 and a right guide rail 21 are connected by the edging. The edging 13 is made of PU polyurethane material, which serves to protect the light-transmitting layer and connect the light-transmitting layer to other components. A height of the hollow layer 14 can be adjusted by modifying the encapsulation process and the structure of the guide rails 21.

As shown in FIGS. 6-8, the first pull rod 33 which can be made of metal or plastic includes interconnected first fixing parts 331 and second fixing parts 332. The first fixing parts 331 between the first light-transmitting layer 11 and the guide rails 21 are connected to sliders 43. The second fixing parts 332, located in the hollow layer 14 together with the curtain fabric 31, are connected to the curtain fabric 31 by sewing or bonding.

As shown in FIG. 12(a) and FIG. 12(b), a length of the second light-transmitting layer 12 is less than a length of the first light-transmitting layer 11. If the front side of the second light-transmitting layer 12 is close to the front side of the first light-transmitting layer 11, the two front sides are connected by the edging 131 formed through the encapsulation process. As shown in FIG. 12(c), if the length of the second light-transmitting layer 12 is relatively short and the front side of the second light-transmitting layer 12 is away from the front side of the first light-transmitting layer 11, the front side of the second light-transmitting layer 12 is connected to a middle portion of the first light-transmitting layer 11 through the edging 131.

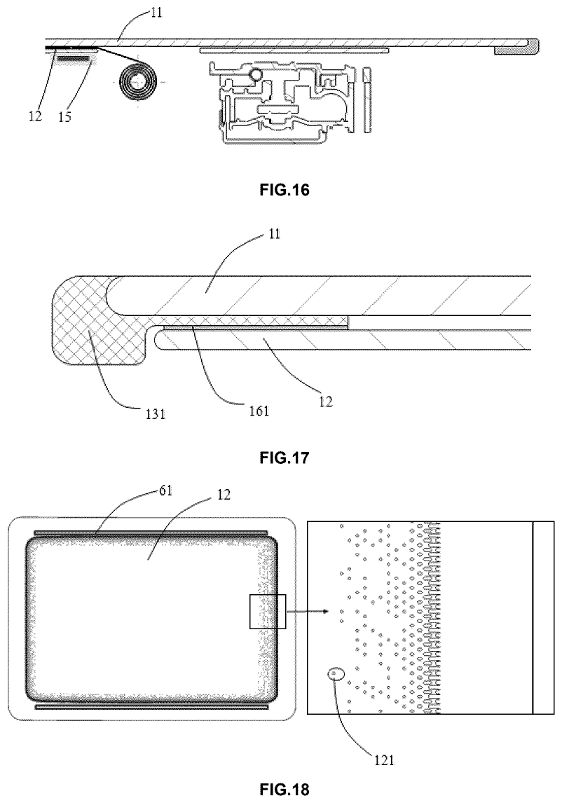

As shown in FIG. 13, if the second light-transmitting layer 12 is made of a material with relatively high stiffness such as a tempered light-transmitting layer, the rear side of the second light-transmitting layer 12 does not need to be fixed and can be suspended. To reduce the weight of the second light-transmitting layer 12, the second light-transmitting layer 12 may be made of a plastic ABS sheet (e.g., an organic transparent light-transmitting layer) to achieve the weight reduction. Due to the insufficient stiffness of the plastic ABS sheet, a collapse risk may exist on the suspended rear side of the second light-transmitting layer 12. To solve this problem, as shown in FIG. 16, the present invention preferably provides a support member 15 below the opening 141 (i.e., a rear bottom of the second light-transmitting layer 12). A top of the support member 15 is connected to the second light-transmitting layer 12 by bonding or PU edging. Left and right sides of the support member 15 are connected to the first light-transmitting layer 11 by bonding or PU edging, thereby providing support and preventing the collapse of the rear side of the second light-transmitting layer 12.

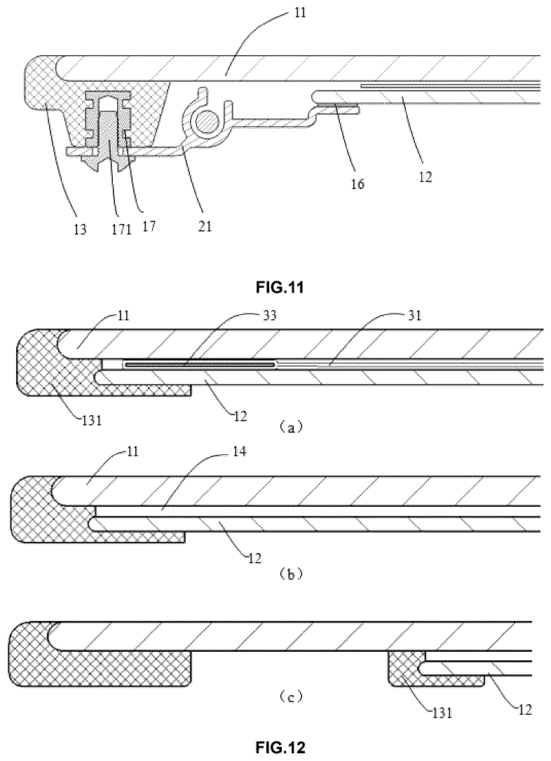

In the above embodiments, the height of the hollow layer 14 is difficult to control since a relative position of the first light-transmitting layer 11 and the second light-transmitting layer 12 is fixed using the PU edging. Meanwhile, during the repair process, disassembly becomes inconvenient, leading to a higher scrap rate and increased production costs and challenges. Therefore, in a preferred embodiment of the present invention, as shown in FIG. 11, the left and right sides of the first light-transmitting layer 11 are connected to fasteners by the edging 13 formed through the encapsulation process. Specifically, the fasteners are nuts 17. First ends of the guide rails 21 are connected to the left and right sides of the second light-transmitting layer 12 through the edging or an adhesive 16, and second ends of the guide rails 21 are provided with screws 171. The relative position of the first light-transmitting layer 11 and the second light-transmitting layer 12 is fixed by the fastening and detachable connection between the screws 171 and the nuts 17. Specifically, the adhesive 16 is a double-sided adhesive. Those skilled in the art may also select other adhesive materials as needed.

Similarly, as shown in FIG. 17, the front side of the second light-transmitting layer 12 can be directly connected to the front side of the first light-transmitting layer 11, which is provided with the edging 131 formed through the encapsulation process, using the adhesive 161. Alternatively, the screws and nuts can be connected to the front sides of the second light-transmitting layer 12 and the first light-transmitting layer 11, respectively, through the edging. The coordination between the screws and the nuts enables a secure yet detachable connection between the first light-transmitting layer 11 and the second light-transmitting layer 12.

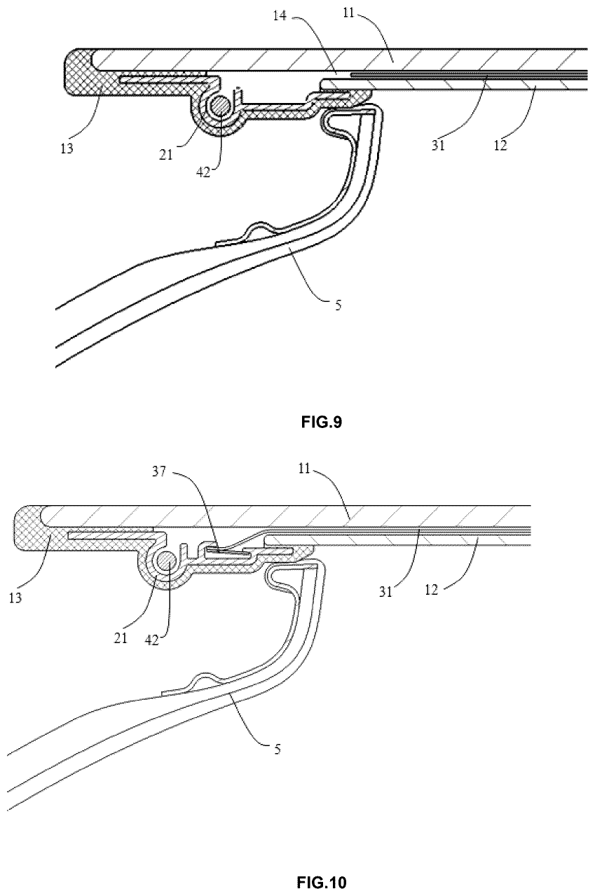

Since the second light-transmitting layer 12 is sufficient to provide overall support for the curtain fabric 31, as shown in FIG. 9, in the present invention, the guide belts typically used in the prior art may not be necessary on the left and right sides of the curtain fabric 31, and the front and rear sides of the curtain fabric 31 may be fixed solely by the first pull rod 33 and the reel 32 as shown in FIG. 6.

As shown in FIG. 13 and FIG. 14, the sunshade curtain assembly 3 further includes connecting shafts 36 fixed to the frame assembly 2 through supports 35. The connecting shafts 36 are connected to the reel 32 through torsion springs. The torsion springs provide a pre-tightening force, inducing the reel 32 to exhibit a rotational tendency that winds the curtain fabric 31 onto the reel 32. This facilitates the orderly storage of the curtain fabric 31 and reduces the storage space.

Furthermore, the sunshade curtain assembly 3 can be simplified by removing the connecting shafts 36, as shown in FIG. 10 and FIG. 15. Instead, an elastic guide belt 37, extending along a length direction of the curtain fabric 31, is provided on each of the left and right sides of the curtain fabric 31 and disposed in each of the guide rails 21. The elastic guide belt 37 is a coil spring with a high restoring force. The coil spring tends to roll the curtain fabric 31 onto the reel 32 and serves the same purpose as a combination of the torsion spring and a spring shaft.

In order to meet the increasingly diverse needs for personalized aesthetics, the automobile sunroof sunshade curtain structure of the present invention further includes a light-emitting portion electrically connected to an external power supply. The light-emitting portion is provided below the first light-transmitting layer 11. The light-emitting portion works in conjunction with the second light-transmitting layer 12 and/or the curtain fabric 31 to form a light-emitting pattern, thereby providing illumination and enhancing the aesthetic appeal of the automobile's interior.

The following describes three embodiments related to the light-emitting portion.

### Embodiment 1

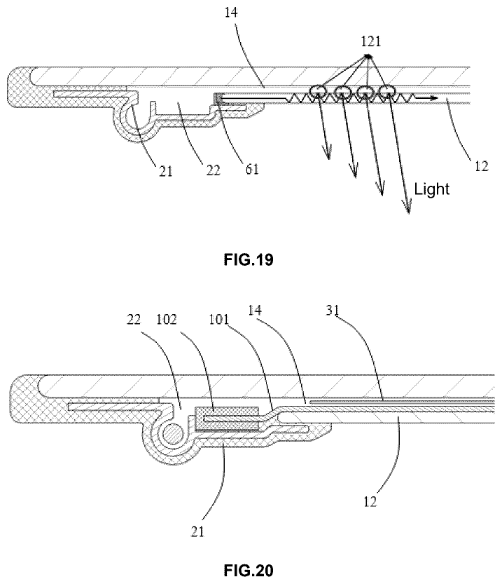

As shown in FIG. 18 and FIG. 19, a plurality of pattern portions 121 is provided on an upper surface of the second light-transmitting layer 12 by using methods such as printing, chemical etching, and engraving. Specifically, the light-emitting portion includes a light bar 61 and a light holder. The light bar 61 is connected to a power supply through the light holder. The light bar 61 and the light holder are disposed in an assembly space 22 between the guide rails 21 and the first light-transmitting layer 11. The light bar 61 extends along a length direction (i.e., front-rear direction) of the second light-transmitting layer 12. A length of the light bars 61 is approximately equal to the length of the second light-transmitting layer 12. The assembly space 22 is located on a left or right side of the hollow layer 14 and is in communication with the hollow layer 14. The light emitted by the light bar 61 enters the second light-transmitting layer 12 through a left or right side end surface of the second light-transmitting layer 12 and propagates within the layer. Upon reaching the pattern portions 121, the light is refracted or scattered and subsequently emitted from a lower surface of the second light-transmitting layer 12, forming a light-emitting pattern. The shape of the plurality of pattern portions 121 and the overall pattern formed by the plurality of pattern portions 121 are not limited. Each pattern portion 121 may be circular, rectangular, star-shaped, etc. The plurality of pattern portions 121 may be disposed around an edge of the upper surface of the second light-transmitting layer 12 to form an ambient light strip, or may be laid flat on the upper surface of the second light-transmitting layer 12 to form a starry sky structure.

### Embodiment 2

As shown in FIGS. 20-22, the light-emitting portion includes a light holder and a transparent display screen. The transparent display screen is disposed on an upper surface of the second light-transmitting layer 12 and is located below the curtain fabric 31. The transparent display screen is configured to not interfere with the normal operation of the curtain fabric 31. When powered off, the transparent display screen remains transparent. Specifically, the transparent display screen can be implemented as an LED transparent display screen 101 or an OLED transparent display screen 103.

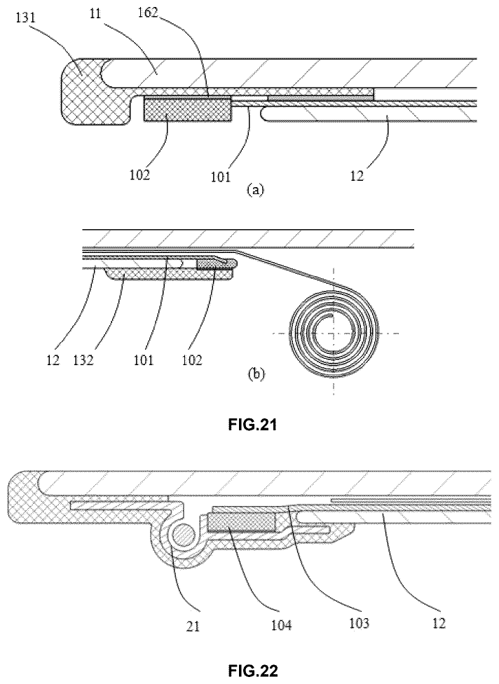

As shown in FIG. 20 and FIG. 21, the LED transparent display screen 101 includes a plurality of light bars arranged in parallel and at intervals. When not powered, the light bars do not emit light, and the entire LED transparent display screen 101 remains in a transparent state. End portions of the light bars are connected to a power supply through light holders 102. The light holders 102 are disposed at front, back, left, and right sides of the LED transparent display screen 101. The light holders 102 on the left and right sides of the LED transparent display screen 101 are located in the assembly space 22. The light holder 102 on the front side of the LED transparent display screen 101 may be bonded to the edging 131 on the front side of the first light-transmitting layer 11 through the adhesive 102. The light holder 102 on the rear side of the LED transparent display screen 101 is connected to the rear side of the second light-transmitting layer 12 through the edging 132 formed by the encapsulation process.

As shown in FIG. 22, the OLED transparent display screen 103 is connected to the power supply through light holder 104. The light holder 104 may be provided on any side of the OLED transparent display screen 103. For example, the light holder 104 may be provided in the assembly space 22, or on the left or right side of the OLED transparent display screen 103.

### Embodiment 3

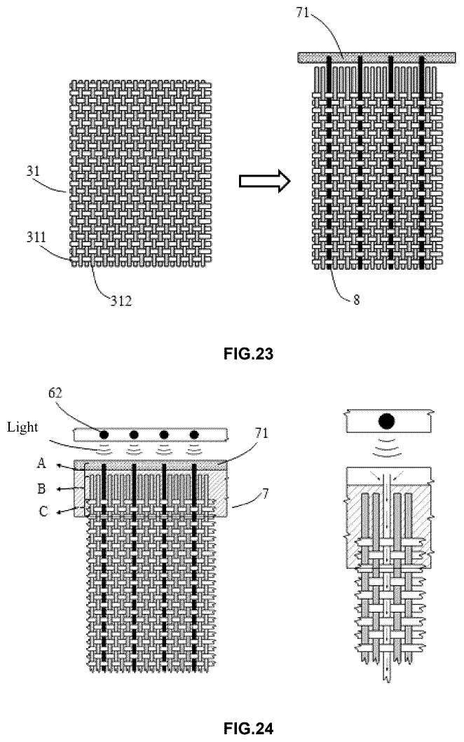

As shown in FIG. 23 and FIG. 24, the curtain fabric 31 is woven using a cross-weaving process and includes a plurality of weft threads 311 (e.g., white lines in the figure) extending along a left-right direction of the second light-transmitting layer 12 and a plurality of warp threads 312 (e.g., gray lines in the figure) extending along a front-rear direction of the second light-transmitting layer 12.

In order to enable the curtain fabric 31 to glow, in the Embodiment 3, the plurality of warp threads 312 is substituted with optical fibers 8 (e.g., black lines in the figure). Specifically, the light-emitting portion includes a light bar and a light holder. The light bar is connected to a power supply through the light holder. The light bar and the light holder may be arranged on the front or rear side of the curtain fabric 31 to allow light to enter the optical fibers 8 from front or rear end of the optical fibers 8.

Preferably, the light-emitting portion is provided on the front side of the curtain fabric 31. A length of the optical fibers 8 is greater than a length of the warp threads 312. The optical fibers 8 have their rear ends flush with, and front ends in front of, those of the warp threads 312. The curtain fabric 31 includes three regions A, B, and C arranged from front to rear. The region A, closest to light bar 62, includes only optical fibers 8. The region B includes both optical fibers 8 and warp threads 312, while the region C includes optical fibers 8, warp threads 312, and weft threads 311. Front ends of the optical fibers 8 are fixed. A light-transmitting portion 71 is formed by injection molding the region A and a transparent plastic (e.g. a transparent organic light-transmitting layer/acrylic material). Then, a second pull rod 7 is formed by connecting the region B, a front side of the region C, and the light-transmitting portion 71 into one piece through an injection molding process. The second pull rod 7 can replace the first pull rod 33 with both ends directly connected to the sliders in the guide rails. The second pull rod 7, driven by the driving assembly, moves the curtain fabric 31 back and forth. The light-transmitting portion 71, made of transparent plastic through injection molding, allows the light emitted by the light bar 62 to enter the optical fibers 8 and connects the regions B and C. As shown in FIG. 6, the rear side of the curtain fabric 31 is connected to the reel 32 in the same manner as in the prior art.

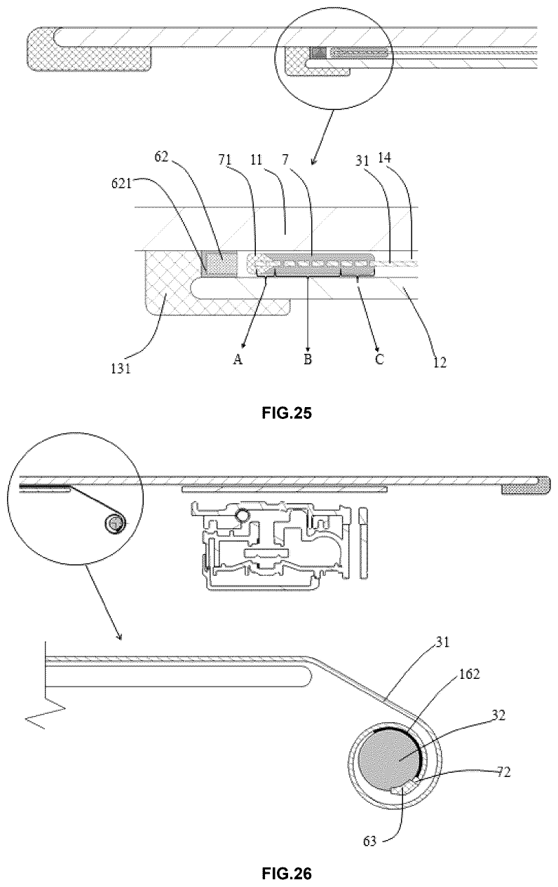

As shown in FIG. 25, the front side of the second light-transmitting layer 12 is connected to the first light-transmitting layer 11 through the edging 131. Both the light bar 62 and the light holder 621 are disposed in the hollow layer 14, at a connection position between the edging 131 and the second light-transmitting layer 12. The light bar 62 extends along a width direction (i.e., the left-right direction) of the second light-transmitting layer 12 with a width close to that of the second light-transmitting layer 12. When the driving assembly 4 moves the second pull rod 7 to the front side of the second light-transmitting layer 12, the curtain fabric 31 is fully extended. In this case, the light bar 62 can be activated by a control system. The light from the light bar 62 passes through the hollow layer 14, the light-transmitting portion 71, and the optical fibers 8, and finally enters and illuminates the curtain fabric 31.

As shown in FIG. 26, those skilled in the art can also set the light-emitting portion on the rear side of the curtain fabric 31 as needed to align the front ends of the optical fibers 8 with the front ends of the warp threads 312 and position the rear ends of the optical fibers 8 behind the rear ends of the warp threads 312. The three regions A, B, and C may be arranged from rear to front in the curtain fabric 31. The light bar 63 and the light holder may be fixed on the reel 32. Then a connecting portion 72 is formed by injection molding the region A and the transparent plastic. The connecting portion 72, the region B, and the region C are all connected to the reel 32 through an adhesive 162. As shown in FIG. 6, in this embodiment, identical to the prior art, the front side of the curtain fabric 31 is connected to the first pull rod 33. When the driving assembly 4 moves the first pull rod 33 to the front side of the second light-transmitting layer 12, the curtain fabric 31 is fully extended. In this case, the light bar 63 can be activated by the control system. The light from the light bar 63 passes through the curtain fabric 31, the connecting portion 72, and the optical fibers 8, and finally enters and illuminates the curtain fabric 31.

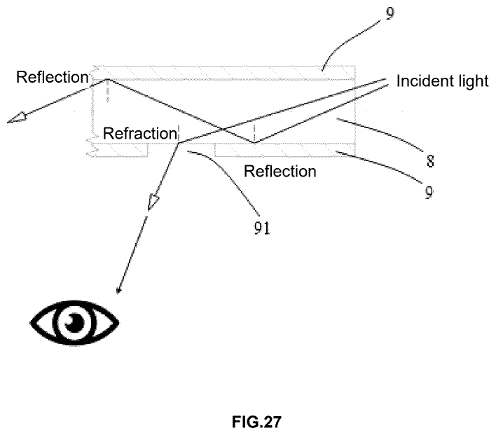

As shown in FIG. 27, those skilled in the art may also wrap an optical fiber sheath 9 on an outer side of the curtain fabric 31. Specifically, the optical fiber sheath 9 is made of fluoroplastic and has a black color or a color similar to that of the sunshade curtain, such as beige, gray, etc. A plurality of notches 91 located directly below the optical fibers 8 is provided on a lower surface of the optical fiber sheath 9 by mechanical wear, chemical corrosion, etc. The light in the optical fibers 8 can refract through the notches 91 and shine out from the lower surface of the second light-transmitting layer 12. Based on the shape formed by the plurality of notches 91, a brighter luminous pattern with a better light-dark contrast is formed, thereby enhancing the visual experience of the passengers in the automobile.

The above are only the preferred embodiments of the present invention. It should be noted that, for those skilled in the art, several improvements and substitutions can be made without departing from the technical principles of the present invention. These improvements and substitutions should also be regarded as the protection scope of the present invention.

1. An automobile sunroof sunshade curtain structure, comprising a first light-transmitting layer (11), a frame assembly (2) comprising two guide rails (21) symmetrically provided below left and right sides of the first light-transmitting layer (11), and a sunshade curtain assembly (3), wherein the structure further comprises a second light-transmitting layer (12) provided below the first light-transmitting layer (11) to form a hollow layer (14) between the two layers (11,12), and a curtain fabric (31) of the sunshade curtain assembly (3) is located in the hollow layer (14).

2. The structure according to claim 1, wherein the two guide rails (21) are respectively connected to left and right sides of the second light-transmitting layer (12), front or rear side of the second light-transmitting layer (12) is connected to the first light-transmitting layer (11), and the opposite side is provided with an opening (141) for the curtain fabric (31) to enter the hollow layer (14).

3. The structure according to claim 2, wherein the left sides of the first and second light-transmitting layers (11,12) and a left guide rail (21) are connected by an edging formed through an encapsulation process, and the right sides of the first and second light-transmitting layers (11,12) and a right guide rail (21) are connected by the edging formed through the encapsulation process.

4. The structure according to claim 2, wherein the left and right sides of the first light-transmitting layer (11) are connected to fasteners by an edging formed through an encapsulation process, first sides of the guide rails (21) are connected to the second light-transmitting layer (12), and second sides of the guide rails (21) are detachably connected to the fasteners.

5. The structure according to claim 2, wherein the front or rear side of the second light-transmitting layer (12) is connected to the first light-transmitting layer (11) by an edging formed through an encapsulation process or an adhesive.

6. The structure according to claim 2, wherein a support member (15) for supporting the second light-transmitting layer (12) is provided at a bottom of the opening (141), and the support member (15) is connected to the first light-transmitting layer (11).

7. The structure according to claim 1, further comprising a light-emitting portion electrically connected to a power supply, wherein the light-emitting portion is disposed below the first light-transmitting layer (11) and coordinates with the second light-transmitting layer (12) and/or the curtain fabric (31) to form a light-emitting pattern.

8. The structure according to claim 7, wherein multiple pattern portions (121) are provided on an upper surface of the second light-transmitting layer (12), and light emitted by the light-emitting portion enters and propagates through the second light-transmitting layer (12), then is refracted or scattered by the pattern portions (121) before being emitted from a lower surface of the second light-transmitting layer (12).

9. The structure according to claim 7, wherein the light-emitting portion includes a transparent display screen disposed on an upper surface of the second light-transmitting layer (12).

10. The structure according to claim 7, wherein the curtain fabric (31) includes multiple optical fibers (8) extending along a front-rear direction of the second light-transmitting layer (12), and light emitted by the light-emitting portion enters the optical fibers (8) through an end portion of the optical fibers (8).

11. The structure according to claim 7, wherein the light-emitting portion includes a light holder and a light bar (61) connected to the power supply through the light holder, both of which are disposed in an assembly space (22) between the guide rails (21) and the first light-transmitting layer (11), and the assembly space (22) is in communication with the hollow layer (14).

12. The structure according to claim 11, wherein light emitted by the light bar (61) enters the second light-transmitting layer (12) through a left or right end surface of the second light-transmitting layer (12).

13. The structure according to claim 11, wherein the light bar (61) extends along a length direction of the second light-transmitting layer (12) with a length approximately equal to that of the second light-transmitting layer (12).

14. The structure according to claim 9, wherein the transparent display screen is an LED transparent display screen (101) or an OLED transparent display screen (103), wherein the LED transparent display screen (101) comprises multiple light bars arranged in parallel at intervals, and when not powered, the light bars do not emit light, and the entire LED transparent display screen (101) maintains a transparent state.

15. The structure according to claim 10, wherein the curtain fabric (31) further includes multiple weft threads (311) and multiple warp threads (312) extending in a left-right direction and a front-rear direction of the second light-transmitting layer (12), respectively.

16. The structure according to claim 15, wherein the curtain fabric (31) includes a region A, a region B, and a region C, wherein the region A includes only the optical fibers (8), the region B includes both optical fibers (8) and warp threads (312), while the region C includes optical fibers (8), warp threads (312), and weft threads (311).

17. The structure according to claim 16, wherein the light-emitting portion is arranged on a front side of the curtain fabric (31), with the regions A, B, and C arranged from front to rear in the curtain fabric (31); a light-transmitting portion (71) is formed by injection molding the region A with transparent plastic; and a second pull rod (7), formed by injection molding the light-transmitting portion (71), the region B and a front side of the region C, is connected to sliders in the guide rails (21) and driven by the driving assembly to move the curtain fabric (31) back and forth.

18. The structure according to claim 16, wherein the light-emitting portion is disposed on a reel (32) located on a rear side of the curtain fabric (31), with the regions A, B, and C arranged from rear to front in the curtain fabric (31), and a connecting portion (72) formed by injection molding the region A with transparent plastic is connected to the regions B and C via an adhesive (162) and the reel (32).

19. The structure according to claim 10, wherein an outer side of the curtain fabric (31) is wrapped with an optical fiber sheath (9), and multiple notches (91) located directly below the optical fibers (8) are provided on a lower surface of the optical fiber sheath (9).

20. The structure according to claim 19, wherein the optical fiber sheath (9) is made of fluoroplastic.
